(19) United States
(12) Patent Application Publication
(10) Pub. No.: US 2024/0412061 A1
(43) Pub. Date: Dec. 12, 2024

(54) DETERMINING VARIABLE INPUT VALUES CORRESPONDING TO A KNOWN OUTPUT VALUE USING NEURAL NETWORKS

(71) Applicant: International Business Machines Corporation, Armonk, NY (US)

(72) Inventors: Sathya Santhar, Chennai (IN); Sridevi Kannan, Chennai (IN); Sarbajit K. Rakshit, Kolkata (IN)

(21) Appl. No.: 18/331,362

(22) Filed: Jun. 8, 2023

(51) Int. Cl. G06N 3/08

(52) U.S. Cl. CPC G06N 3/08

(57) ABSTRACT

One or more systems, devices, computer program products and/or computer-implemented methods of use provided herein relate to determination of a variable input value based on a known output value. The computer-implemented system can comprise a memory that can store computer executable components. The computer-implemented system can further comprise a processor that can execute the computer executable components stored in the memory, wherein the computer executable components can comprise a neural network model that can determine a value for at least one variable input parameter in a first dataset, based on one or more fixed input parameter values in the first dataset and one or more respective fixed input parameter values in a second dataset, such that the value can yield a known output value in the first dataset.

### BACKGROUND

The subject disclosure relates to neural networks and, more specifically, to determining variable input values corresponding to a known output value using neural networks.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable prediction of an optimal input dimension based on a preferred classified output are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a neural network model that can determine a value for at least one variable input parameter in a first dataset, based on one or more fixed input parameter values in the first dataset and one or more respective fixed input parameter values in a second dataset, such that the value can yield a known output value in the first dataset.

According to another embodiment, a computer-implemented method is provided. The method can comprise determining, by a system operatively coupled to a processor, using a neural network model, a value for at least one variable input parameter in a first dataset, based on one or more fixed input parameter values in the first dataset and one or more respective fixed input parameter values in a second dataset, such that the value can yield a known output value in the first dataset.

According to yet another embodiment, a computer program product for predicting a value of an input parameter that can yield an output parameter value via neural networks is provided. The computer program product can comprise a computer readable storage medium having program instructions embodied therewith, the program instructions executable by a processor to cause the processor to determine, by the processor, using a neural network model, a value for at least one variable input parameter in a first dataset, based on one or more fixed input parameter values in the first dataset and one or more respective fixed input parameter values in a second dataset, such that the value can yield a known output value in the first dataset.

### BRIEF DESCRIPTION OF THE DRAWINGS

FIG. 1 illustrates a block diagram of an example, non-limiting system that can determine, via neural networks, an input parameter value given a known output value in accordance with one or more embodiments described herein.

FIG. 2 illustrates example, non-limiting neural network architectures that can enable determination of an input parameter value given a known output value in accordance with one or more embodiments described herein.

FIG. 3 illustrates an example, non-limiting neural network that can enable determination of an input parameter value given a known output value in accordance with one or more embodiments described herein.

FIG. 4 illustrates a flow diagram of an example, non-limiting method that can enable determination of an input parameter value given a known output value in accordance with one or more embodiments described herein.

FIG. 5 illustrates a flow diagram of example, non-limiting steps employed by a neural network algorithm for computing respective Euclidean distances between fixed parameter values from a first dataset and respective fixed parameter values from a second dataset in accordance with one or more embodiments described herein.

FIG. 6 illustrates an example, non-limiting step employed by a neural network algorithm for selecting a Euclidean distance between a fixed parameter value from a first dataset and a respective fixed parameter value from a second dataset in accordance with one or more embodiments described herein.

FIG. 7 illustrates an example, non-limiting step employed by a neural network algorithm for identifying placement of a synthetic point on a Euclidean distance in accordance with one or more embodiments described herein.

FIG. 8 illustrates an example, non-limiting step employed by a neural network algorithm for determining a value of a varying input parameter by projecting a synthetic point on a multi-dimensional plane in accordance with one or more embodiments described herein.

FIG. 9 illustrates a flow diagram of an example, non-limiting method that can determine, via neural networks, an input parameter value given a known output value in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Neural networks are based on nature since neural networks are biologically inspired representations of the human brain wherein neurons interconnected to other neurons form a network and simple information can transit within the neurons before becoming an act or outcome (e.g., moving a hand to pick up a pencil). A neural network can comprise a series of algorithms that can endeavor to recognize underlying relationships in a set of data through a process that mimics the way the human brain operates. In this sense, neural networks refer to systems of neurons, either organic or artificial in nature. An operation of a complete neural network can be defined in a straightforward manner, wherein variables can be entered as inputs (e.g., an image can be an input to a neural network designed to identify what is on an image), and the neural network can generate an output (e.g., a neural network can analyze an image of a cat to return the word “cat”) after performing various calculations. An example of a neural network is the Google search algorithm.

Neural networks with complex algorithms used for predictive analysis are commonly studied in the art. Widely used for data classification, neural networks can process past and current data to estimate future values and discover several complex correlations hidden in data in a manner analogous to the human brain. As such, mathematical functions within a neural network are called neurons. Neural networks can be used to make predictions on time series data such as weather data and designed to detect patterns in input data to produce an output free of noise. Neural networks can be classified into different types, and different neural network are used for different purposes. The following non-exhaustive list of neural networks comprises the most common types of neural networks.

Perceptron (one of the oldest neural networks created in 1958 by Frank Rosenblatt) comprises a single neuron. Perceptron can be described as the simplest form of a neural network.

Feedforward neural networks, or multi-layer perceptrons (MLPs) can comprise an input layer, one or more hidden layers, and an output layer. Although commonly referred to as MLPs, feedforward neural networks are comprised of sigmoid neurons, not perceptrons, since most real-world problems can be nonlinear. Data can be fed into feedforward neural network models for training the models, and the models are foundations for computer vision, natural language processing, and other neural networks.

Convolutional neural networks (CNNs) can be similar to feedforward neural networks, and can be commonly utilized for image recognition, pattern recognition, and/or computer vision. CNNs can utilize principles from linear algebra, particularly matrix multiplication, to identify patterns within an image.

Recurrent neural networks (RNNs) can be identified by their feedback loops. RNN learning algorithms can be primarily utilized for time-series data to make predictions about future outcomes (e.g., stock market predictions or sales forecasting).

Deep neural networks (DNNs) can be neural networks comprising more than three layers including inputs and an output. A DNN can be considered a deep learning algorithm, wherein the word “deep” can refer to a depth of layers in a neural network. A neural network comprising only two or three layers is a basic neural network.

Additional examples of artificial neural networks (ANNs) include radial basis neural networks, multilayer perception models, modular neural networks and sequence-to-sequence models. Neural networks can adapt to changes in input. Thus, a neural network can generate the best possible outcome without requiring a redesign of an output criterion.

In a machine learning task, given a set of input parameters (features) and an output parameter (target), a neural network model can be trained using a set of input and output parameter pairs, and the neural network model can be employed to predict the output (given the input). An input layer of the neural network can feed historical data values into a hidden layer. The hidden layer can comprise neurons that can assist the neural network to make predictions, generate outcomes, etc. For each neuron in a hidden layer, the hidden layer can perform calculations using some (or all) of the neurons in the previous layer of the neural network. The values can then be used in the next layer of the neural network. Neural networks can be trained using a cost function, which is an equation that can measure error contained in a prediction made by the neural network (e.g., square of a difference between a predicted output value of an observation and an actual output value of that observation, divided by 2). The goal of an ANN can be to minimize a value of the cost function. The value of the cost function can be minimized when a predicted value of an algorithm can be as close to the actual value as possible. In other words, the goal of a neural network can be to make predictions with minimum error.

As stated above, neural networks can reflect behaviour of the human brain, allowing computer programs to recognize patterns and solve common problems in the fields of artificial intelligence (AI), machine learning, and deep learning. Further, machine learning and deep learning libraries can comprise functions and methods to quickly execute tasks. Neural networks can rely on training data to learn and improve their accuracy over time. Upon fine-tuning for accuracy, learning algorithms can become efficient tools in computer science and AI, enabling classification and clustering of data at a high velocity. For example, neural networks are swiftly gaining popularity in the development of trading systems. Machine learning tasks can utilize strong mathematical and statistical concepts to solve many sophisticated problems. For example, tasks in speech recognition or image recognition can require minutes versus hours in comparison to manual identification by human experts.

However, existing techniques surrounding neural networks are focused on utilizing input parameters to a neural network for predicting/classifying an output value or utilizing a total number of trainable parameters in a feed-forward neural network with n hidden layers to generate the output value. Such existing techniques do not focus on finding/predicting input parameter values or ranges based on known output values, which can be helpful in solving many real-life problems. For example, given a set of input parameters and output parameters recorded during a project lifecycle process, wherein the input parameters can be input values to a process that produces a project output, it can be desirable to identify a set of values for some input parameters that can have the greatest likelihood of yielding a certain output parameter or a preferred project status. The input parameters thus predicted can be useful to a project management team. The value for a variable input parameter can be found using random values via trial and error, however, such a method can lead to a large computational overhead.

Embodiments described herein include systems, computer-implemented methods, apparatus and computer program products that can determine a value for at least one variable input parameter given one or more fixed input parameter values and a known output parameter value corresponding to the variable input parameter. The value for the variable input parameter can be found via a neural network that can be trained on interpolation between preferred instances. For example, a neural network can be trained, wherein based on input parameters to the neural network, weights and biases can be learnt, and the input parameters can be adjusted during back propagation to produce desired values and correct outputs to reduce loss. The trained neural network and training data used to train the neural network can be further utilized at a subsequent level of training for training a new neural network that can predict applicable and relevant input parameters based on the known output parameter value. Variable input parameter values can be predicted via interpolation on a plane (e.g., a multi-dimensional plane) based on the known output parameter value and the one or more fixed input parameter values (e.g., standard input parameters that cannot be changed).

More specifically, various embodiments described herein can enable interpolation and mapping techniques on a high dimensional plane, via a neural network model, wherein unknown varying values can be predicted based on known output values and other standard parameters. For example, class A and class B can be output values, and X₁, X₂, X₃, X₄, X₅, X₆, X₇, X₈, X₉ and X₁₀ can be input parameters corresponding to a user of the neural network. Of the input parameter values, X₁-X₈ can be standard parameters that cannot be varied or adjusted by the user (e.g., age, marital status, etc. of the user) and X₉ and X₁₀ can be varying and predictable input parameters (e.g., annual income of a user, etc.) that can be analysed to determine eligibility of the user for class A (e.g., eligibility to qualify for a housing loan, etc.). Class A can be defined as a preferred output class (e.g., preferred by the user).

Given training datasets 1, 2, . . . , n used to train the neural network model, various embodiments described herein can identify the varying input parameters for an n+1 dataset, wherein the n+1 dataset can be a user-provided dataset comprising a preferred class value (e.g., class A) and values for other standard parameters (e.g., X₁-X₈) provided by the user. Various embodiments described herein can assist the user to analyse and predict the values for the varying input parameters X₉ and X₁₀ for which the user can become eligible to fall under class A, given the standard parameters X₁-X₈. For example, various embodiments described herein can comprise an algorithm that can perform iterations to generate a range of values for the varying input parameters X₉ and X₁₀ that can yield class A as an output of another algorithm or another neural network model (e.g., an algorithm that can determine housing loan eligibility for the user).

More specifically, values for the standard parameters (e.g., X₁-X₈) from the user-provided dataset n+1 as well as from the training datasets 1, 2, . . . , n used to train the neural network model and the preferred output class (e.g., class A) can be plotted on a multi-dimensional plane with unknown values for X₉ and X₁₀ that need to be predicted. An iteration for determining values for the varying input parameters X₉ and X₁₀ can start with measurement of Euclidean distances between values for the standard parameters X₁-X₈ from the training datasets and the user-provided dataset, respectively. A general formula for calculating a Euclidean distance is described in equation 1. The algorithm can calculate the Euclidean distances for k nearest neighbours, wherein k can be specified as an argument in a new function. The shortest distance between respective values for the standard parameters X₁-X₈ from the training datasets and the user-provided dataset can be identified. In other words, a nearest neighbouring value of a standard parameter of the training datasets from the respective value of a standard parameter from the user-provided dataset can be identified.

$$Euclidean distance = \sqrt{{( {x}_{2} - {x}_{1} )}^{2} + {( {y}_{2} - {y}_{1} )}^{2}} for points ( {x}_{1} , {y}_{1} ) and ( {x}_{2} , {y}_{2} ) . \qquad Equation 1$$

Upon identification of the nearest neighboring value, a synthetic point can be placed anywhere on a line joining a point under consideration (e.g., a point X₁-X₈ from the user-provided dataset) and its chosen neighbour (e.g., a corresponding point X₁-X₈ from the training datasets) to identify exact values of the unknown/varying input parameters X₉ and X₁₀. For achieving the exact values, a distance value of the line can be multiplied with a random number between [0,1] to identify placement of the synthetic point within a distance vector representing the line such that the synthetic point can fall under class A. The synthetic point can be projected onto a multi-dimensional plane, and projections of the synthetic point on the multi-dimensional plane can generate values for the unknown/varying input parameters X₉ and X₁₀. The algorithm can repeat for multiple iterations, wherein a range of values for the unknown/varying input parameters X₉ and X₁₀ for class A can be computed. Thus, one iteration of the multiple iterations can generate one value without a trial-and-error approach.

Embodiments described herein can focus on feature values modification, wherein such modification can be continuous or discreet. Embodiments described herein can describe an approach towards plotting known features in a lower dimensional plane followed by projecting the features on to a higher dimensional plane to identify new values for desired features that can be comprised in a plane of a desired classifier within the higher dimensional plane, as opposed to minimizing or maximizing a function. Such an approach can involve less computation or extensive searches (e.g., in comparison to genetic algorithms that can start with a random population and slowly converge towards an optimal value which can result in local minima instead of a global minimum). Such an approach can be more efficient for solving problems without relying on identifying a correct objective function, which can be a challenge with genetic algorithms (e.g., selection of a correct fitness function can be a highly complex task given an amount of features in a question).

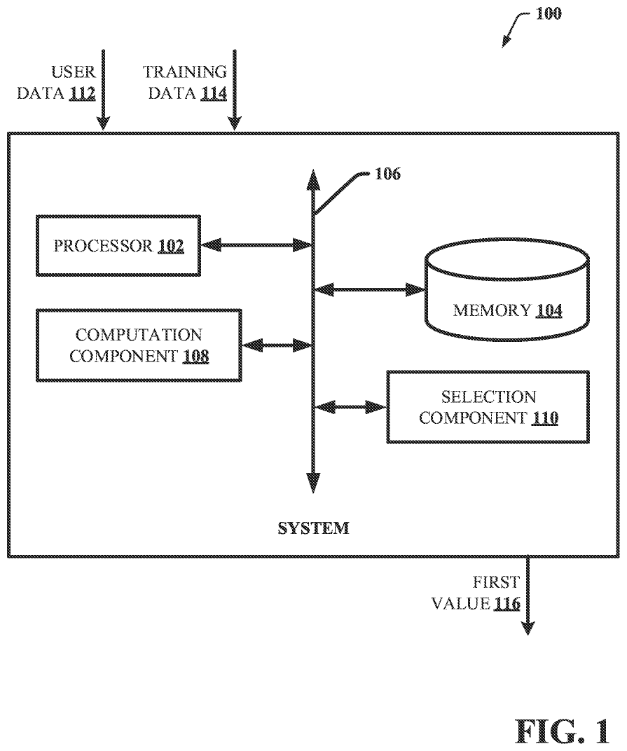

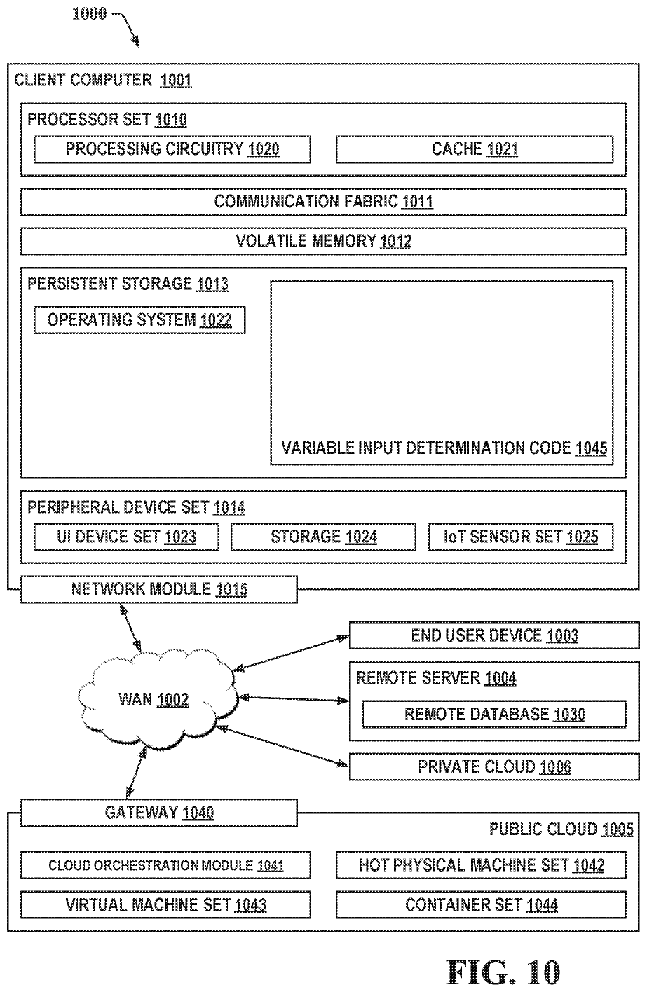

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIG. 10 and/or with other figures described herein.

FIG. 1 illustrates a block diagram of an example, non-limiting system 100 that can determine, via neural networks, an input parameter value given a known output value in accordance with one or more embodiments described herein. System 100 can comprise processor 102, memory 104, system bus 106, computation component 108 and selection component 110.

The system 100 and/or the components of the system 100 can be employed to use hardware and/or software to solve problems that are highly technical in nature (e.g., related to machine learning, neural networks, determining an input parameter value given a known output value using a neural network model, etc.), that are not abstract and that cannot be performed as a set of mental acts by a human. Further, some of the processes performed may be performed by specialized computers for carrying out defined tasks related to the determining of the input parameter value given the known output value using a neural network model. The system 100 and/or components of the system can be employed to solve problems that arise due to large computational overheads on neural network models and the like. The system 100 can provide technical improvements to machine learning systems, deep learning systems and AI systems by improving their accuracy, reducing delay in processing performed by processing components in a machine learning system, deep learning system and/or an AI system, and/or reducing computational overheads on neural networks, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component (e.g., computation component 108, selection component 110, etc.) associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., computation component 108 and/or selection component 110) to perform one or more actions. In one or more embodiments, memory 104 can store computer-executable components (e.g., computation component 108 and/or selection component 110).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, computation component 108 can compute respective Euclidean distances between one or more fixed input parameter values in a first dataset and one or more respective fixed input parameter values in a second dataset. Thereafter, selection component 110 can select a Euclidean distance from the respective Euclidean distances, such that a distance vector for the Euclidean distance can be smaller than a first defined threshold. Computation component 108 can perform additional computations based on the Euclidean distance selected by selection component 110, as described in greater detail below. System 100 can be associated with, such as accessible via, a computing environment 1000 described below with reference to FIG. 10. For example, system 100 can be associated with a computing environment 1000 such that aspects of processing can be distributed between system 100 and the computing environment 1000.

In one or more embodiments, system 100 can comprise a neural network model that can determine a value (e.g., first value 116) for at least one variable input parameter in a first dataset (e.g., user data 112), based on one or more fixed input parameter values in the first dataset and one or more respective fixed input parameter values in a second dataset (e.g., training data 114), such that the value can yield a known output value in the first dataset. The first dataset can comprise information provided by a user of the neural network model, wherein the known output value can belong to a class selected by the user, and the second dataset can comprise training data for the neural network model.

For example, in an embodiment, for determining the value of the variable input parameter, the neural network can plot (e.g., using computation component 108) the one or more fixed input parameter values from the first dataset and the one or more fixed input parameter values from the second dataset on a first plane (e.g., a lower-dimensional plane). Computation component 108 can compute respective Euclidean distances between the one or more fixed input parameter values in the first dataset and the one or more respective fixed input parameter values in the second dataset. Computation component 108 can compute the respective Euclidean distances for an amount of the one or more respective fixed input parameter values in the second dataset that fall within a defined distance from the one or more fixed input parameter values in the first dataset.

Thereafter, selection component 110 can select a Euclidean distance from the respective Euclidean distances, such that a distance vector for the Euclidean distance can be smaller than a first defined threshold, to enable the determination of the value. In an embodiment, determining the value can comprise multiplying (e.g., by computation component 108) the Euclidean distance with a random number between 0 and 1, identifying a point (e.g., by computation component 108) on the distance vector such that the point falls under a class in the second dataset corresponding to a known output value, and projecting the point (e.g., by computation component 108) on a multi-dimensional plane. Determining the value using the respective Euclidean distances can maintain a computational load on the neural network model below a second defined threshold.

In a non-limiting example, a neural network algorithm can generate first value 116 that can yield a known output value. User data 112 can comprise one or more variable input parameters, one or more fixed input parameters, and the known output value. The known output value can correspond to a class selected by a user of a neural network model. Training data 114 can comprise one or more training datasets used for training the neural network model. User data 112 and training data 114 can be inputs for the neural network model. One or more fixed input parameter values from training data 114, corresponding to the one or more fixed input parameter values from user data 112, can be projected/plotted (e.g., by computation component 108, the neural network model/algorithm) on a first plane (e.g., a lower-dimensional plane).

Thereafter, the one or more fixed input parameter values from user data 112 can be projected/plotted (e.g., by computation component 108, the neural network model/algorithm) on the first plane. Computation component 108 can compute respective Euclidean distances between the one or more fixed input parameter values from user data 112 and the one or more fixed input parameter values from training data 114. The computation can be performed for fixed values from training data 114 that are within a defined distance from fixed values from user data 112. Further, the computation can be performed for parameters that are analogous (e.g., an age of the user from user data 112 and one or more other age values from training data 114).

After computation of the respective Euclidean distances, the shortest Euclidean distance can be selected (e.g., by selection component 110, the neural network model/algorithm) for further computation, such that a fixed input parameter value from training data 114, associated with the shortest Euclidean distance, can fall under the class selected by the user. A distance vector representing the shortest Euclidean distance can be multiplied by a random number between [0, 1] to generate a new number. A synthetic point can be plotted (e.g., by computation component 108, the neural network model/algorithm) on the distance vector such that a distance between the fixed input parameter value from user data 112, associated with the shortest Euclidean distance, and the synthetic point, can be equal to the new number, causing the synthetic point to belong to the class selected by the user.

After plotting of the synthetic point, values from the first plane (e.g., lower dimensional plane) can be projected on to a second plane (e.g., higher dimensional plane). The second plane can comprise additional dimensions (e.g., in addition to dimensions comprised in the first plane) corresponding to the one or more variable input parameter values from user data 112. Projection of the values on to the second plane can cause synthetic point to be projected on dimensions of the second plane corresponding to variable values from user data 112. A value obtained by projection of the synthetic point on the dimension of the second plane corresponding to the variable values from user data 112 can be first value 116. The process can be repeated to generate a range of values for first value 116 such that any value from the range of values can yield the known output value.

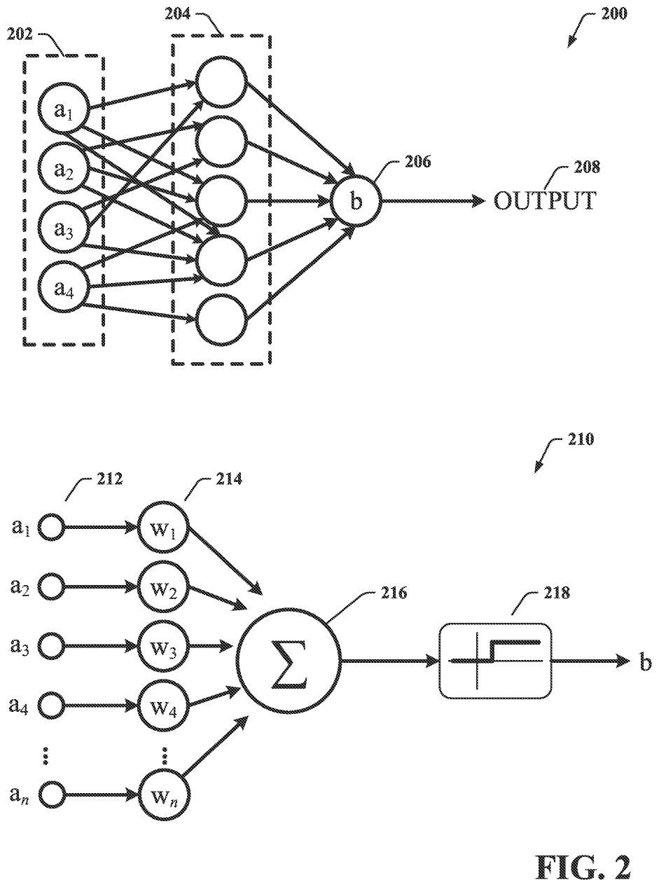

FIG. 2 illustrates example, non-limiting neural network architectures 200 and 210 that can enable determination of an input parameter value given a known output value in accordance with one or more embodiments described herein. Repetitive description of like elements and/or processes employed in respective embodiments is omitted for sake of brevity.

Neural network architecture 200 can represent a neural network that can be used to implement the one or more embodiments discussed herein. Neural network architecture 200 can comprise input later 202, a hidden layer 204 and an output layer 206 that can generate output 208. Input nodes of the neural network are illustrated as a₁, a₂, a₃ and a₄ in black circles, wherein input nodes a₁, a₂, a₃ and a₄ can comprise input values to the neural network (e.g., area (feet²), number of bedrooms, distance to a city (miles), age of an individual, etc.).

Hidden layer 204 can encapsulate several complex functions that can create predictors, and such functions can often be hidden from a user/entity using the neural network. Nodes (black circles) at hidden layer 204 can represent mathematical functions that can modify input data from input later 202. For example, in an embodiment, hidden layer 204 can comprise an algorithm that can determine a range of values for variable input parameters corresponding to a known output value by performing interpolation between respective fixed input parameter values from a first dataset and a second dataset plotted on a multi-dimensional plane. Output layer 206 can collect predictions made by hidden layer 204 and produce output 208.

Neural network architecture 210 can additionally represent a neural network that can be used to implement the one or more embodiments discussed herein. Neural network architecture 200 can comprise input later 212 comprising nodes a₁, a₂, a₃, a₄, . . . , an. Neural network architecture 200 can comprise hidden later 214 comprising weights w₁, w₂, w₃, w₄, . . . , wₙ. At 216, the neural network can generate a sum of weighted outputs based on information from input layer 212 and hidden layer 214 (e.g., Σ₌₁ⁿaⱼwⱼ). At 218, an activation function can analyse the sum to generate output b.

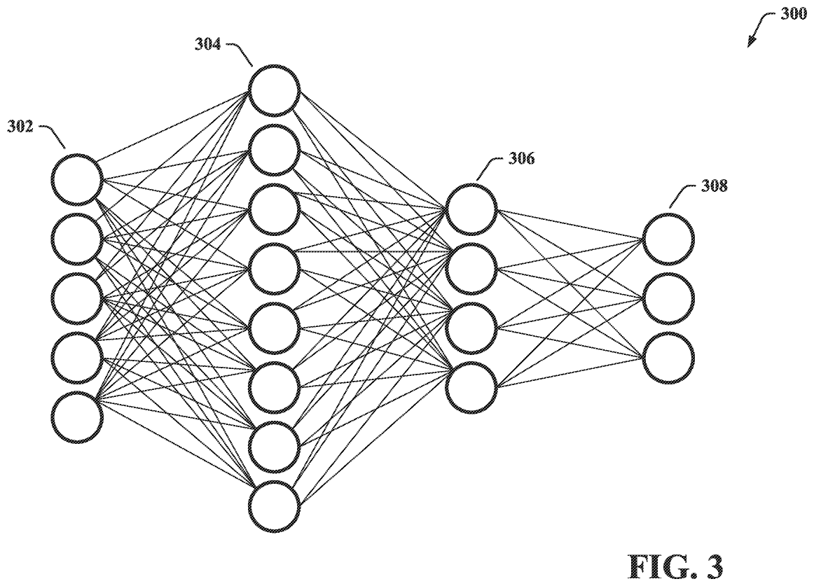

FIG. 3 illustrates an example, non-limiting neural network 300 that can enable determination of an input parameter value given a known output value in accordance with one or more embodiments described herein. Repetitive description of like elements and/or processes employed in respective embodiments is omitted for sake of brevity.

As stated elsewhere herein, a neural network can be trained, wherein based on input parameters to the neural network, weights and biases can be learnt, and the input parameters can be adjusted during back propagation to produce desired values and correct outputs to reduce loss. The neural network and training data used to train the neural network can be further utilized at a next level for training neural network 300, wherein neural network 300 can predict applicable and relevant input parameters based on a known output value from a first dataset. Variable input parameter values can be predicted via interpolation on a multi-dimensional plane based on the known output value and one or more fixed input parameter values (e.g., standard input parameters that cannot be changed) from the first dataset and respective fixed input parameter values from the second dataset. Neural network 300 can be a deep neural network comprising input layer 302, hidden layer 304, hidden layer 306 and output layer 308.

In a non-limiting example, a loan eligibility decision made by banks for an applicant can be based on various parameters (e.g., social identity, marital status, age, salary, service period, credit history, Credit Information Bureau (India) Limited (CIBIL) score, credit score, etc.) relevant/significant to the loan eligibility decision. If the various parameters corresponding to the applicant have values that satisfy certain conditions or rules, the loan can be approved for the applicant. In other words, the decision made by a bank can fall under an “approved” category. Alternately, if the values do not satisfy the rule, the loan can be rejected for the applicant. In other words, the decision made by the bank can fall under a “not approved” category. In the later scenario, neural network 300 can assist the applicant to identify varying parameters (e.g., credit history, CIBIL score, etc.) and respective values or ranges of values for the varying parameters that can cause the loan to be approved by an algorithm (e.g., a loan eligibility determination algorithm).

With continued reference to the above example, the various input parameters provided by the applicant (e.g., social identity, marital status, age, salary, service period, credit history, CIBIL score, etc.) can be divided into two categories. A first category can comprise fixed input parameters (e.g., social identity, marital status, age, salary, service period, etc.) having fixed values and a second category can comprise variable input parameters (e.g., credit history, CIBIL score, etc.) having variable values. The “approved” and “not approved” categories can be defined as possible output values or classes (e.g., class A and class B, respectively), wherein the “approved” category can be an output value preferred by the applicant. Neural network 300 can receive the “approved” category as a known output value/preferred class value (e.g., preferred by the applicant). Neural network 300 can additionally receive fixed input parameter values (e.g., social identity, marital status, age, salary, service period, etc.) from the applicant (e.g., as user data 112 of FIG. 1) and respective fixed input parameter values from training datasets (e.g., as training data 114 of FIG. 1) used for training neural network model 300. Neural network 300 can process the received data to determine variable input parameter values (e.g., credit history, CIBIL score, etc.) for the applicant based on the known output value and the fixed parameter values from data provided by the applicant and the training datasets, additional aspects of which are disclosed with reference to subsequent figures.

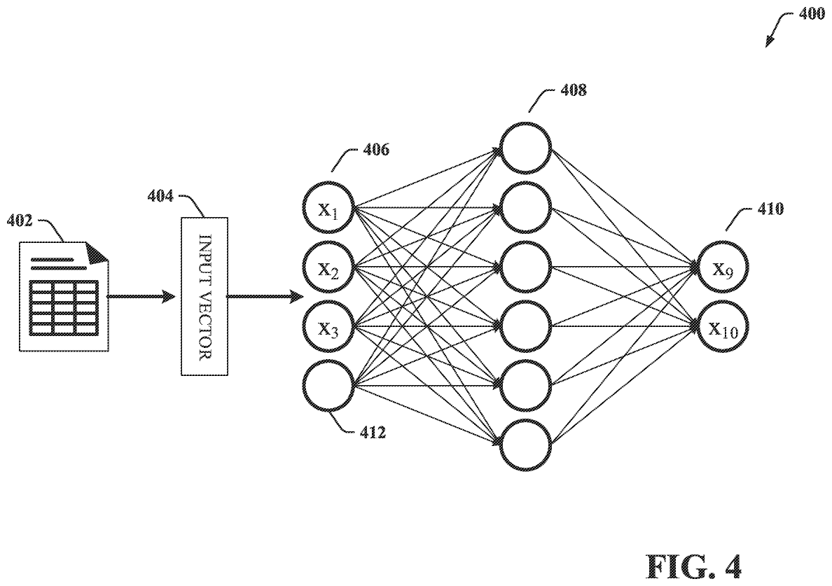

FIG. 4 illustrates a flow diagram of an example, non-limiting method 400 that can enable determination of an input parameter value given a known output value in accordance with one or more embodiments described herein. Repetitive description of like elements and/or processes employed in respective embodiments is omitted for sake of brevity.

With continued reference to the non-limiting example from FIG. 3, varying parameters (e.g., credit history, CIBIL score, etc.) and respective values or ranges of values for the varying parameters that can cause a loan to be approved by a bank for an applicant can be identified via method 400. Input data 402 can comprise the “approved” category as a known output value/preferred class value selected by the applicant and the fixed input parameter values (e.g., social identity, marital status, age, salary, service period, etc.) for the applicant. Input data 402 can additionally comprise historical data/training data used to train the neural network model. Input data 402 can be provided to a neural network in the form of input vector 404.

The neural network can comprise an input layer 406 with input nodes. Individual fixed input parameter values (e.g., social identity, marital status, age, salary, service period, etc.) for the applicant and respective fixed input parameter values from the training data can be provided to input nodes of the neural network for computation of variable input parameter values (e.g., credit history, CIBIL score, etc.) for the applicant. The known output value (e.g., “approved” class) can be provided to the neural network model at node 412. In the non-limiting example illustrated in FIG. 4, X₁, X₂ and X₃ can be the marital status, age and service period of the applicant, and X₉ and X₁₀ can be the credit history and credit score of the applicant. The neural network can process the X₁, X₂ and X₃ values for the applicant to identify the X₉ and X₁₀ values that the applicant can attempt to achieve such that a bank loan can be approved for the applicant.

The neural network can further comprise hidden layer 408 and output layer 410. As illustrated in FIG. 3, the neural network can be a DNN and hidden layer 408 can represent one or more hidden layers. Hidden layer 408 can employ an algorithm to process information received from input layer 406 for computation of the variable input parameter values. Output later 410 can process information generated by and received from hidden layer 408 to identify respective values for the variable input parameters that can yield the known output value (e.g., “approved” class). Additional aspects of the algorithm utilized for generation of the variable input parameter values are disclosed with reference to subsequent figures.

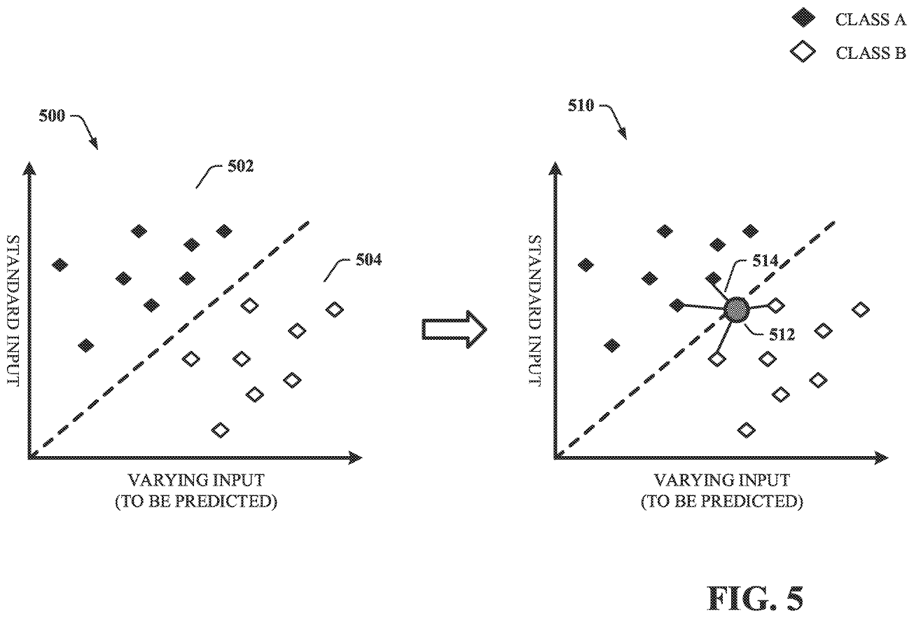

FIG. 5 illustrates a flow diagram of example, non-limiting steps employed by a neural network algorithm for computing respective Euclidean distances between fixed parameter values from a first dataset and respective fixed parameter values from a second dataset in accordance with one or more embodiments described herein. Repetitive description of like elements and/or processes employed in respective embodiments is omitted for sake of brevity.

With continued reference to the non-limiting example from FIGS. 3 and 4, a neural network can employ an algorithm for identification of varying parameters (e.g., credit history, CIBIL score, etc.) and respective values or ranges of values for the varying parameters that can cause the loan to be approved by banks. As a first step, the algorithm can plot one or more fixed input parameter values (e.g., social identity, marital status, age, salary, service period, etc.) from the training data (e.g., training data 114 of FIG. 1) corresponding to respective one or more fixed input parameter values (e.g., social identity, marital status, age, service period, etc.) from data provided by the applicant (e.g., user data 112 of FIG. 1) on plane 500. At this stage, variable input parameter values from the training data corresponding to respective variable input parameter values from data provided by the applicant can be excluded for plotting. The fixed input parameter values from the training data can correspond to different output classes (e.g., “approved” class/class A and “not approved”/class B) as respectively illustrated at 502 and 504 on plane 500. An imaginary margin M illustrated by the dashed line can distinguish class A and class B on plane 500.

The dimensions of plane 500 can be equal in number to the number of fixed input parameters (e.g., a three-dimensional plane for fixed input parameter values X₁, X₂ and X₃, and so on) from the training data corresponding to the number of fixed input parameters from data provided by the applicant. Likewise, each dimension of plane 500 can comprise one point (corresponding to one fixed input parameter value from the training data). Thus, it is to be appreciated that although eight parameter values are illustrated as plotted in each output class (e.g., as solid filled and empty filled diamonds) on plane 500, for purposes of simplicity, plane 500 is illustrated as having only two dimensions/axes (as opposed to eight dimensions/axes). The above description is also applicable to planes 510, 600 and 800, wherein planes 500, 510 and 600 are analogous.

As a second step, the algorithm can plot fixed input parameter values (e.g., social identity, marital status, age, salary, service period, etc.) from data provided by the applicant on plane 500 to generate plane 510. For example, point 512 on plane 510 can be representative of one or more fixed parameter values from the data provided by the applicant. The fixed parameter values represented by point 512 can correspond to a situation wherein a loan is rejected for the applicant. Thus, point 512 can fall into class B/towards class B or the “not approved” category, as illustrated in FIG. 5, and a goal of the algorithm can be to identify the varying parameter values for the applicant that can cause point 512 to move towards class A.

As a third step, the algorithm can compute respective Euclidean distances between the fixed input parameter values from data provided by the applicant and respective fixed input parameter values from the training data. For example, the line 514 can be a Euclidean distance computed by the algorithm between the age of the applicant and an age value (e.g., of another individual) comprised in the training data. Similarly, other lines originating from point 512 can be Euclidean distances between the age of the applicant and other age values (e.g., of other individuals) comprised in the training data (e.g., since the training data can comprise historical data used to train the neural network).

The respective Euclidean distances can be calculated for k nearest values of the fixed parameter values from the training data from the respective fixed parameter values from the data provided by the applicant, wherein k can be a parameter that can be defined for a neural network model. In the non-limiting example illustrated in FIG. 5, k can be equal to 4 (k=4) since four Euclidean distances are illustrated. In other words, four fixed parameters values/k nearest neighboring values from the training data can be selected for each of the fixed parameters (e.g., social identity, marital status, age, salary, service period, etc.), wherein the four fixed parameters values can fall within a defined distance from the respective fixed parameter values from point 512.

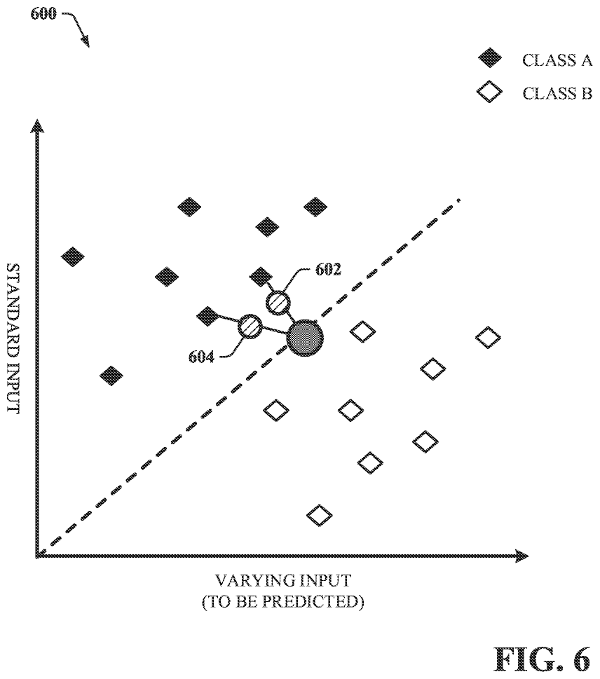

FIG. 6 illustrates an example, non-limiting step employed by a neural network algorithm for selecting a Euclidean distance between a fixed parameter value from a first dataset and a respective fixed parameter value from a second dataset in accordance with one or more embodiments described herein. Repetitive description of like elements and/or processes employed in respective embodiments is omitted for sake of brevity.

With continued reference to the embodiments of at least FIG. 5, the algorithm can select, as a fourth step, one or more Euclidean distances for each fixed parameter, from the respective Euclidean distances computed at the third step, such that fixed values from the training data (e.g., corresponding to the fixed values from data provided by the applicant) can fall under class A on plane 600. For example, as illustrated in FIG. 6, only two out of the four respective Euclidean distances computed at the third step can be selected for further computation, since only two of the four fixed parameter values selected at the third step fall under class A (i.e., k nearest neighbours=2 within class A).

As a fifth step, the algorithm can identify a synthetic point on a Euclidean distance out of the one or more Euclidean distances, wherein a length of a distance vector representing the Euclidean distance is smaller that a defined threshold (e.g., smaller that the remaining Euclidean distances calculated for a fixed parameter). In other words, for each fixed parameter, the algorithm can identify a synthetic point on the shortest Euclidean distance out of the one or more Euclidean distances computed for a fixed parameter. For example, point 602 can be the synthetic point or point 604 can be the synthetic point. Additional aspects of determining the placement of the synthetic point are illustrated in subsequent figures.

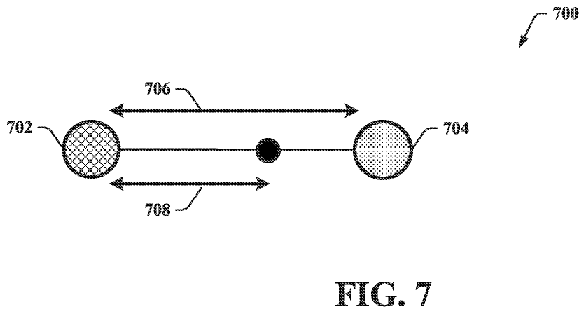

FIG. 7 illustrates an example, non-limiting step 700 employed by a neural network algorithm for identifying placement of a synthetic point on a Euclidean distance in accordance with one or more embodiments described herein. Repetitive description of like elements and/or processes employed in respective embodiments is omitted for sake of brevity.

With continued reference to the embodiments of at least FIG. 6, the algorithm can employ step 700 to determine a placement of the synthetic point on the Euclidean distance selected at the fifth step. For example, at step 700, the algorithm can multiply the length of the distance vector representing the shortest Euclidean distance with a number from [0, 1] to generate a new number. The synthetic point can be placed at a distance equal to the new number from a fixed parameter value from the data provided by the applicant, causing the synthetic point to fall under a known output class. For example, point 702 can be a fixed parameter value (e.g., X₁-X₈) for the applicant and point 704 can be the respective fixed parameter value (e.g., X₁-X₈) from the training data. The algorithm can multiple the length of distance vector 706 (e.g., 1 unit) with a number between 0 and 1 (e.g., 0.6 units) to generate the new number (e.g., 0.6 units). The synthetic point (illustrated as the solid black circle) can be placed on distance vector 706 such that distance 708 is equal to the new number (e.g., 0.6 units).

Stated differently, a position r₁ of the synthetic point on a distance vector connecting a fixed parameter value (e.g., X₁) from a user-provided dataset and a fixed parameter value (e.g., X₁₁) from the training data can be equal to a position of X₁ (e.g., equivalent fixed parameter value from user-provided data) plus a product of a gap between the synthetic point and X₁ and a length of the distance vector connecting X₁ and X₁₁ (e.g., r₁=X₁+(gap×difference))

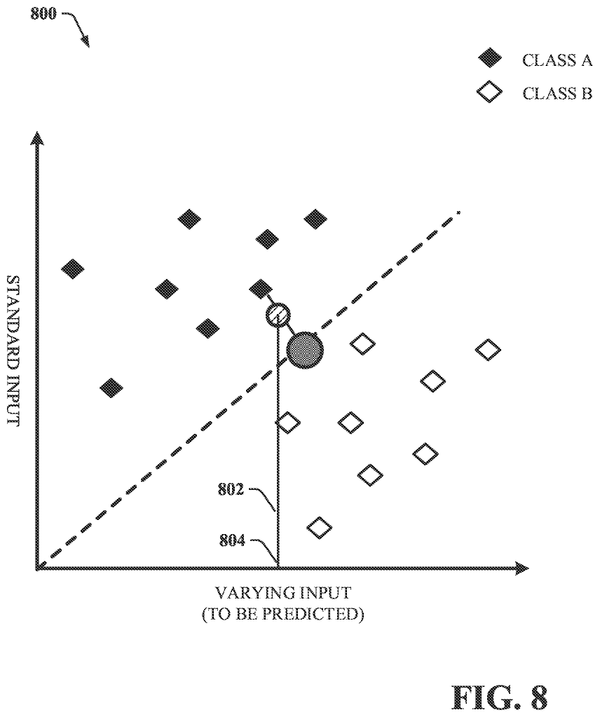

FIG. 8 illustrates an example, non-limiting step employed by a neural network algorithm for determining a value of a varying input parameter by projecting a synthetic point on a multi-dimensional plane in accordance with one or more embodiments described herein. Repetitive description of like elements and/or processes employed in respective embodiments is omitted for sake of brevity.

With continued reference to the embodiments of at least FIG. 6, the algorithm can project, as a sixth step, plane 600 onto plane 800, wherein plane 800 can comprise additional dimensions corresponding to one or more variable parameter values that the algorithm can determine. After determining position of the synthetic point (e.g., point 602 or point 604), values from plane 600 can be projected onto plane 800. Plane 800 can be a multi-dimensional plane comprising higher dimensions than plane 600, since plane 800 can comprise additional dimensions (e.g., in addition to dimensions comprised in plane 600) corresponding to one or more variable input parameter values to be determined/predicted by the algorithm for the applicant. In a non-limiting example, plane 600 can comprise eight dimensions and plane 800 can comprise ten dimensions.

Projection of the values onto plane 800 can cause the synthetic point to be projected on dimensions of plane 800 corresponding to respective variable parameters to be determined for the applicant. The projection of the synthetic point on a dimension of plane 800 corresponding to a variable input parameter can generate a value of the variable input parameter (e.g., first value 116 of FIG. 1). In a non-limiting example, projection 802 of point 602 on a dimension corresponding to a varying input parameter on plane 800 can generate value 804. The process can be repeated for multiple iterations to determine a range of values for each of the one or more variable input parameters that can cause a loan to be approved for the applicant. For example, a length of a distance vector on which the synthetic point can be placed, can be multiplied with a different random number from [0, 1] to identify a different placement for the synthetic point during each iteration. The projections of the different placements for the synthetic point on a multi-dimensional plane (e.g., plane 800) can identify a range of values for the one or more variable input parameters.

It is to be appreciated that the label “varying input (to be predicted)” in FIGS. 5 and 6 can indicate that planes 500, 510 and 600 can comprise dimensions corresponding to only fixed parameter values, whereas the same label in FIG. 8 can indicate that plane 800 can comprise additional dimension(s) corresponding to respective varying parameter values to be predicted, in addition to the dimensions in planes 500, 510 and 600. As stated elsewhere herein, planes 500, 510 and 600 are analogous.

Thus, one or more embodiments herein describe a method for finding a value of a variable input feature to obtain a value corresponding to an output class (e.g., an output class preferred by a user of the neural network model) as an output from the neural network model, wherein the neural network model can be fed with both, the variable input feature and one or more fixed input features. The method can comprise obtaining training datasets of the neural network model, wherein each training dataset can comprise a plurality of input feature values and a corresponding class. The method can further comprise receiving, for the model, input feature values and the output class from the user, wherein one or more of the input feature values can be fixed and one or more other feature values can be adjustable to obtain the output class.

The method can further comprise calculating, for each dataset, Euclidean distances between fixed input feature values and respective input feature values from the training dataset to find closest neighboring values within the output class in the training datasets. The method can further comprise multiplying the shortest Euclidean distance with a random number between [0,1] and finding a point on a distance vector of the shortest Euclidean distance such that the point falls under the output class. Adjustable input feature values can be identified based on the point, in accordance with one or more embodiments discussed herein. The computations described above (e.g., calculating, multiplying, and determining) can be iterated to generate a range of values for adjustable input features.

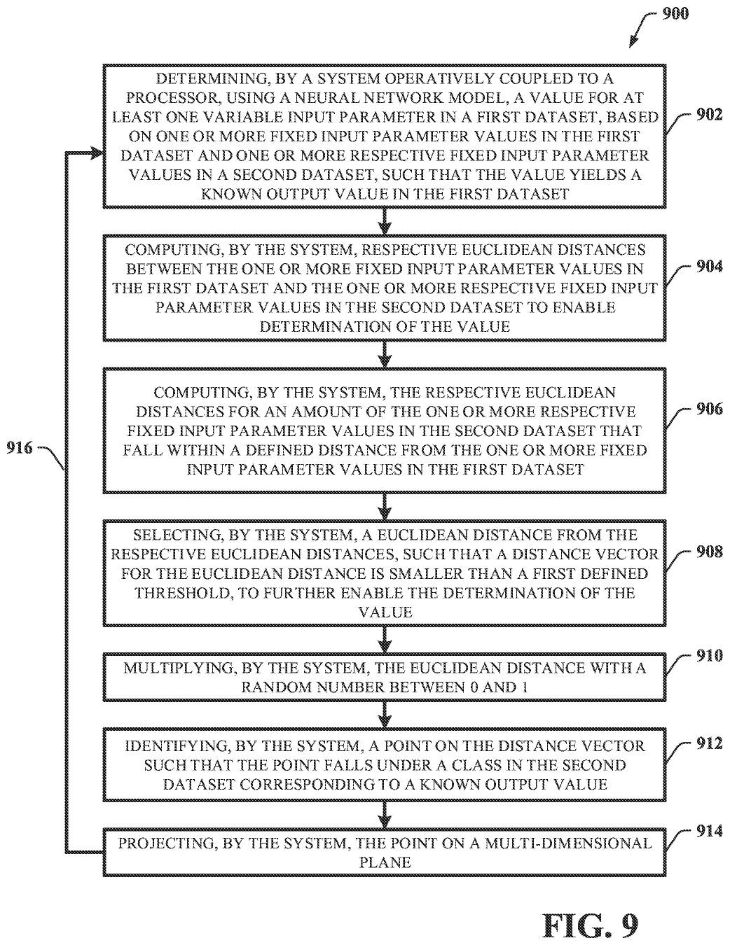

FIG. 9 illustrates a flow diagram of an example, non-limiting method 900 that can determine, via neural networks, an input parameter value given a known output value in accordance with one or more embodiments described herein. Repetitive description of like elements and/or processes employed in respective embodiments is omitted for sake of brevity.

At 902, the non-limiting method 900 can comprise determining (e.g., by computation component 108), by a system operatively coupled to a processor, using a neural network model, a value for at least one variable input parameter in a first dataset, based on one or more fixed input parameter values in the first dataset and one or more respective fixed input parameter values in a second dataset, such that the value yields a known output value in the first dataset.

At 904, the non-limiting method 900 can comprise computing (e.g., by computation component 108), by the system, respective Euclidean distances between the one or more fixed input parameter values in the first dataset and the one or more respective fixed input parameter values in the second dataset to enable determination of the value.

At 906, the non-limiting method 900 can comprise computing (e.g., by computation component 108), by the system, the respective Euclidean distances for an amount of the one or more respective fixed input parameter values in the second dataset that fall within a defined distance from the one or more fixed input parameter values in the first dataset.

At 908, the non-limiting method 900 can comprise selecting (e.g., by selection component 110), by the system, a Euclidean distance from the respective Euclidean distances, such that a distance vector for the Euclidean distance is smaller than a first defined threshold, to further enable the determination of the value.

At 910, the non-limiting method 900 can comprise multiplying (e.g., by computation component 108), by the system, the Euclidean distance with a random number between 0 and 1.

At 912, the non-limiting method 900 can comprise identifying (e.g., by computation component 108), by the system, a point on the distance vector such that the point falls under a class in the second dataset corresponding to a known output value.

At 914, the non-limiting method 900 can comprise projecting (e.g., by computation component 108), by the system, the point on a multi-dimensional plane.

At 916, the non-limiting method 900 can repeat steps 902-914 for multiple iterations to generate a range of values for the at least one variable input parameter.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively compute a value for an input parameter to a neural network given a known output value corresponding to the value, using fixed parameter values and large amounts of training data used to train the neural work model as the one or more embodiments described herein can enable this process. And, neither can the human mind nor a human with pen and paper execute multiple iterations of a process to compute additional values for the input parameter to determine a range of values for the input parameter, as conducted by one or more embodiments described herein.

FIG. 10 illustrates a block diagram of an example, non-limiting, operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as variable input determination code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed:

1. A system, comprising:
a memory that stores computer-executable components; and
a processor that executes the computer-executable components stored in the memory, wherein the computer-executable components comprise:
a neural network model that determines a value for at least one variable input parameter in a first dataset, based on one or more fixed input parameter values in the first dataset and one or more respective fixed input parameter values in a second dataset, such that the value yields a known output value in the first dataset.

2. The system of claim 1, wherein the first dataset comprises information provided by a user of the neural network model, wherein the known output value belongs to a class selected by the user, and wherein the second dataset comprises training data for the neural network model.

3. The system of claim 1, further comprising:
a computation component that computes respective Euclidean distances between the one or more fixed input parameter values in the first dataset and the one or more respective fixed input parameter values in the second dataset to enable determination of the value.

4. The system of claim 3, wherein the respective Euclidean distances are computed for an amount of the one or more respective fixed input parameter values in the second dataset that fall within a defined distance from the one or more fixed input parameter values in the first dataset.

5. The system of claim 3, further comprising:
a selection component that selects a Euclidean distance from the respective Euclidean distances, such that a distance vector for the Euclidean distance is smaller than a first defined threshold, to further enable the determination of the value.

6. The system of claim 5, wherein determining the value further comprises multiplying the Euclidean distance with a random number between 0 and 1.

7. The system of claim 5, wherein determining the value further comprises identifying a point on the distance vector such that the point falls under a class in the second dataset corresponding to a known output value and projecting the point on a multi-dimensional plane.

8. The system of claim 5, wherein determining the value using the respective Euclidean distances maintains a computational load on the neural network model below a second defined threshold.

9. A computer-implemented method, comprising:
determining, by a system operatively coupled to a processor, using a neural network model, a value for at least one variable input parameter in a first dataset, based on one or more fixed input parameter values in the first dataset and one or more respective fixed input parameter values in a second dataset, such that the value yields a known output value in the first dataset.

10. The computer-implemented method of claim 9, wherein the first dataset comprises information provided by a user of the neural network model, wherein the known output value belongs to a class selected by the user, and wherein the second dataset comprises training data for the neural network model.

11. The computer-implemented method of claim 9, further comprising:
computing, by the system, respective Euclidean distances between the one or more fixed input parameter values in the first dataset and the one or more respective fixed input parameter values in the second dataset to enable determination of the value.

12. The computer-implemented method of claim 11, further comprising:
computing, by the system, the respective Euclidean distances for an amount of the one or more respective fixed input parameter values in the second dataset that fall within a defined distance from the one or more fixed input parameter values in the first dataset.

13. The computer-implemented method of claim 11, further comprising:
selecting, by the system, a Euclidean distance from the respective Euclidean distances, such that a distance vector for the Euclidean distance is smaller than a first defined threshold, to further enable the determination of the value.

14. The computer-implemented method of claim 13, further comprising:
multiplying, by the system, the Euclidean distance with a random number between 0 and 1.

15. The computer-implemented method of claim 13, further comprising:
identifying, by the system, a point on the distance vector such that the point falls under a class in the second dataset corresponding to a known output value; and
projecting, by the system, the point on a multi-dimensional plane.

16. The computer-implemented method of claim 13, wherein determining the value using the respective Euclidean distances maintains a computational load on the neural network model below a second defined threshold.

17. A computer program product for predicting a value of an input parameter that yields an output parameter value via neural networks, the computer program product comprising a computer readable storage medium having program instructions embodied therewith, the program instructions executable by a processor to cause the processor to:
determine, by the processor, using a neural network model, a value for at least one variable input parameter in a first dataset, based on one or more fixed input parameter values in the first dataset and one or more respective fixed input parameter values in a second dataset, such that the value yields a known output value in the first dataset.

18. The computer program product of claim 17, wherein the first dataset comprises information provided by a user of the neural network model, wherein the known output value belongs to a class selected by the user, and wherein the second dataset comprises training data for the neural network model.

19. The computer program product of claim 17, wherein the program instructions are further executable by the processor to cause the processor to:
compute, by the processor, respective Euclidean distances between the one or more fixed input parameter values in the first dataset and the one or more respective fixed input parameter values in the second dataset to enable determination of the value.

20. The computer program product of claim 19, wherein the program instructions are further executable by the processor to cause the processor to:
compute, by the processor, the respective Euclidean distances for an amount of the one or more respective fixed input parameter values in the second dataset that fall within a defined distance from the one or more fixed input parameter values in the first dataset.
